(19) United States
(12) Patent Application Publication
(10) Pub. No.: US 2025/0236534 A1
(43) Pub. Date: Jul. 24, 2025

(54) ELECTROCHROMIC SUPERCAPACITOR APPLICATION OF VANADIUM DOPED COBALT CHLORIDE CARBONATE HYDROXIDE: PROCESS FOR PREPARATION THEREOF

(71) Applicant: COUNCIL OF SCIENTIFIC AND INDUSTRIAL RESEARCH AN INDIAN REGISTERED BODY INCORPORATED, New Delhi (IN)

(72) Inventors: Bikash KUMAR JENA; Swagatika KAMILA, Bhubaneswar, Odisha (IN); Lingaraj PRADHAN, Bhubaneswar, Odisha (IN)

(21) Appl. No.: 18/699,463

(22) PCT Filed: Feb. 1, 2023
(86) PCT No.: PCT/IN2023/050096

§ 371 Date: Apr. 8, 2024

(30) Foreign Application Priority Data
Feb. 2, 2022 (IN) 202211005733

(51) Int. Cl. C01G 51/84; B82Y 40/00

(52) U.S. Cl. CPC C01G 51/84; B82Y 40/00; C01P 2002/54; C01P 2004/03; C01P 2004/04; C01P 2004/64; C01P 2006/40; C01P 2006/60

(57) ABSTRACT

The present invention reports the development of electrochromic supercapacitor application that comprises the vanadium doped cobalt chloride carbonate hydroxide. And, more particularly, developing a process to synthesize for use as electrochromic supercapacitor application. Methods of preparing the material and use for electrochromic supercapacitor application of the invention are also described. The catalyst shows a high capacitance value of the electrochromic supercapacitor having a capacitance value of 1219 F/g in alkaline medium with an optical modulation (ΔT) value of 69% coloration efficiency value of 65 cm2c−1 at a wavelength of 600 nm. This invention provides a new vision for developing materials with dual characters, i.e., storing energy and changing its color for promising electrochromic supercapacitor applications.

### FIELD OF THE INVENTION

The present invention relates to the electrochromic supercapacitor application and, more particularly, developing a process to synthesize vanadium doped cobalt chloride carbonate hydroxide for use as electrochromic supercapacitor application.

### BACKGROUND OF THE INVENTION

With the gradual development of sustainable energy resources in this modern era, the devices like supercapacitors and electrochromic smart windows that are significant for the conversion and storage of energy are the primary requirement for our upcoming generations [Hahn severin et al., DE102016209609A1; Couput jean p et al., U.S. Pat. No. 5,276,547A]. Supercapacitors are attracting significant attention among the various electrochemical energy storage devices due to their high-power density, fast charge/discharge rate, long cycle stability, environmental friendly, etc. [Kim sang ouk et al., US20150183189A1; Sutherland hugh liam et al., US20190365060A1; Gaben Fabien et al., US20210104777A1]. Generally, supercapacitors are considered a bridge connecting the gap between the batteries and the conventional capacitors with a similar configuration consisting of a positive electrode, a negative electrode, and a separator [Faxing Wang et al., Chem. Soc. Rev., 2017, 46, 6816-6854]. In the last decades, there has been a lot of research trending in the direction of developing supercapacitors that can be capable of storing a large amount of energy in a compact area [Poonam et al., Journal of Energy Storage, 2019, 21, 801-825; Weijun Li et al., Electrochimica Acta, 2021, 384, 138344]. With modernization and extensive smart applications, the integration of multifunctional properties like flexibility, shape memory, color change, etc., in supercapacitor devices are sought to extend its application in intelligent electronics [Oukassi sami et al., US20170133166A1; Mun et al., KR102052440B1]. In addition to this, a phenomenon called electrochromism also play a crucial role in this rapidly changing world [Peng sun et al., Small Methods, 2019, 2, 1900731]. The phenomenon through which a material reversibly changes its optical properties due to redox reactions is defined as electrochromism [Hao Wang et al., J. Mater. Chem. C, 2020, 8, 15507]. The electrochromic materials are used to control the flow of light, likely in smart windows, smart sunglasses, anti-glare rear-view mirrors of a car, and in devices for visual information and storage [Jian Chen et al., Nano Lett., 2020, 20, 1915-1922]. For example, applying a certain external potential in an electrochromic smart window can block different types of harmful radiations [Hao Wang et al., J. Mater. Chem. C, 2020, 8, 15507; Deepak P. Dubal et al., Chem. Soc. Rev., 2018, 47, 2065; Zelin Lu et al., Phys. Chem. Chem. Phys., 2021, 23, 14126].

Recently, researchers designed a smart and intelligent supercapacitor by integrating the electrochromic and energy storage properties called an electrochromic supercapacitor [Du lianhuan et al., CN109256281B; Gu zhongze et al., CN109243830A; Cheng fangchao et al., CN111146009A]. There are many materials reported for conventional supercapacitor, which has the only capability of storing energy. However, in an electrochromic supercapacitor, the materials show dual characters, i.e., storing energy and changing its color. One can quickly identify whether the supercapacitor is in charge state or not [Tong et al. Sci China Chem January 2017, 60, 1]. Therefore, the search for new, low-cost, efficient, and robust electrochromic energy storage materials is urgently required for supercapacitor applications [Wang feijun et al., CN103996549BB]. Some metal oxides and their derivatives have been explored for improved electrochromic and electrochemical performance [Junying Xue et al., Journal of Alloys and Compounds, 2021, 857, 158087; Nadia O et al., ACS Appl. Energy Mater., 2021, 4, 3469-3479]. Still, there is continuous research effort for new materials having both optical modulation performance and energy storage.

### OBJECTIVE OF THE INVENTION

The main objective of the present invention is to provide vanadium doped cobalt chloride carbonate hydroxide nanostructure (V-C³H-NSs) process for the preparation thereof for use as electrochromic supercapacitor (ECS) application.

Another objective of the present invention is to provide the synthesis condition and facile process on optimizing the concentration of metal precursors and reagents to form V-C³H-NSs.

Another object of the present invention is to demonstrate the ECS activity of VC³H-NSs.

Yet another object of the present invention is to provide the impact of electrolyte condition on the ECS activity.

### SUMMARY OF THE INVENTION

In an aspect of the present disclosure, there is provided a process for preparation of vanadium doped cobalt chloride carbonate hydroxide nanostructures (V-C³H-NSs), the process comprising the steps of:
a) adding the salt precursors [Cobalt (II) chloride hexahydrate (CoCl₂·6H₂O) and vanadium, chloride (VCl₃), and urea (NH₂CONH₂) in 30 ml of water and stirring the mixture for 15 minutes and sonicate for 30 minutes to obtain a reaction mixture solution;
b) adding 178 mg quantity of salt precursors [CoCl₂·6H₂O] to the reaction mixture solution as obtained in step (a);
c) adding 40 mg of Vanadium chloride (VCl₃) to the reaction mixture solution as obtained in step (a);
d) adding 419 mg of urea (NH₂CONH₂) to the reaction mixture as obtained in step (a);
e) transferring the reaction mixture solution as obtained in step (a) to a teflon-lined 50 ml stainless-steel autoclave and treated in an oven at a temperature in the range of 120° C.-160° C. for a time period in the range of 10-15 hours to result in a precipitate;

f) the precipitate as obtained in step (e) was collected after cooling down to room temperature and washed with deionized (DI) water followed by ethanol to obtain a material; and
g) drying the material as obtained in step (f), in an oven for a time period in the range of 10 to 12 hrs at a temperature in the range of 50 to 70° C. and stored in a desiccator for future use.

Yet in another embodiment of the present invention, the salt precursors, Cobalt (II) chloride hexahydrate (CoCl₂·6H₂O) and vanadium chloride (VCl₃), are used as Co and V sources for the preparation of V-C³H-NSs.

In another embodiment of the present invention, urea is used as a hydrolysis agent and helps in the precipitation of material as obtained in step (e).

In another embodiment of the present invention, the molar concentration of salt precursor [CoCl₂·6H₂O] is in the range of 20-25 mM.

In another embodiment of the present invention, the molar concentration of salt precursor vanadium chloride [VCl₃] is in the range of 5-10 mM.

In another embodiment of the present invention, the molar concentration of urea [NH₂CONH₂] is in the range of 220-240 mM.

Still, in another embodiment of the present invention, the V-C³H-NSs obtained from the process is a useful material for electrochromic supercapacitor, which is useful in designing intelligent windows, smart sunglasses, and in devices for optical information, energy storage, wearable electronics, thermal regulations, and sensing applications, etc.

Another embodiment of the present invention presents the electrode material in the form of a powder having individual nanorods assembled to form flowers like structures.

The certain illustrative embodiment of the present invention is that these materials are stable for electrochromic supercapacitors and show the capacitance value of 1219 Fg⁻¹ at a scan rate of 1 mVs⁻¹ and Coloration efficiency of 65 cm²C⁻¹ at a wavelength of 600 nm and optical modulation (ΔT) 69%.

The present invention envisions the process and method of developing a material described above and its use to impact the electrochromic supercapacitor application positively.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The following drawings form a part of the present specification and are included to further illustrate aspects of the present disclosure. The disclosure may be better understood by reference to the drawings in combination with the detailed description of the specific embodiments presented herein.

FIG. 1 depicts the image of the synthesized V-C³H-NSs product, in accordance with an embodiment of the present disclosure.

FIG. 2 depicts FESEM (Field Emission Scanning Electron Microscopy) images (a, b), EDS (Energy-dispersive X-ray spectroscopy) spectra (c), and color mapping (d) images of V-C³HNSs, in accordance with an embodiment of the present disclosure

FIG. 3 depicts TEM images (a, b), HRTEM (High-Resolution Transmission Electron Microscopy) image (c) and SAED (Selected Area (Electron) Diffraction) pattern (d), of V-C³H-NSs, in accordance with an embodiment of the present disclosure.

FIG. 4 depicts XRD (X-ray Diffraction) spectrum of C³H-NSs and V-C³H-NSs, in accordance with an embodiment of the present disclosure.

FIG. 5: FTIR (Fourier Transform Infrared) spectra of V-C³H-NSs, in accordance with an embodiment of the present disclosure.

FIG. 6 depicts (a) Full XPS (X-ray Photoelectron Spectroscopy) spectrum (a), Co 2p (b), C 1s (c), O 1s (e) V 2p spectra of V-C³H-NSs, in accordance with an embodiment of the present disclosure.

FIG. 7 depicts (a) CV (Cyclic Voltammetry) and (b) CD (Charge-Discharge) of V-C³H-NSs and C³H-NSs, in accordance with an embodiment of the present disclosure.

FIG. 8 depicts (a) CV of V-C³H-NSs at different scan rates, (b) CD of V-C³H-NSs at different current densities, (c) Ragone plot, and (d) cycle stability of C³H-NSs and V-C³H-NSs, in accordance with an embodiment of the present disclosure.

FIG. 9 depicts (a) Optical image and (b) Ultraviolet (UV)-Visible transmittance spectra of V-C³H-NSs at neutral and charged state, in accordance with an embodiment of the present disclosure.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “w/w” means the percentage by weight, relative to the weight of the total composition, unless otherwise specified.

The term “at least one” is used to mean one or more and thus includes individual components as well as mixtures/combinations.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120 to 160° C. should be interpreted to include not only the explicitly recited limits of about 120 to about 160° C., but also to include sub-ranges, such as 125 to 140° C., 150 to 160° C., and so forth, as well as individual amounts, including fractional amounts, within the specified ranges, such as 154.2° C., and 120° C., for example.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

The present disclosure is not to be limited in scope by the specific embodiments described herein, which are intended for the purposes of exemplification only. Functionally equivalent products, compositions, and methods are clearly within the scope of the disclosure, as described herein.

As discussed in the background of the present disclosure, there has been a continuous search for novel, economical, efficient, and robust electrochromic energy storage materials for supercapacitor applications. In this context, a process for synthesizing vanadium doped cobalt chloride carbonate hydroxide nanostructure has been developed from the mixture of cobalt chloride hexahydrate with vanadium chloride and urea with the optimized hydrothermal route followed by washing and drying at optimized temperature. The electrochromic and electrochemical experimentation for supercapacitor application has been demonstrated. The as-developed material shows superior specific capacitance value and a significant color-changing activity compared with the various reported electrochromic energy storage materials.

The process of preparation condition, electrochemical energy storage properties with electrochromic color-changing activity prescribed in this invention is not specified by any other invention so far.

Accordingly, in an embodiment of the present disclosure, there is provided a process for the preparation of vanadium doped cobalt chloride carbonate hydroxide nanostructures (V-C³H-NSs), the process comprising the steps of: (a) adding 20-25 mM of Cobalt (II) chloride hexahydrate (CoCl₂·6H₂O), 5-10 mM of vanadium chloride (VCl₃) and 220-240 mM of urea in 30 ml of water, followed by stirring for 15 to 30 minutes and sonicating for 30 to 45 minutes to obtain a reaction mixture solution; (b) transferring the reaction mixture solution as obtained in step (a) to a Teflon-lined 50 ml stainless-steel autoclave and treating the reaction mixture solution in an oven at a temperature in the range of 120° C.-160° C. for a time period in the range of 10-15 hours to result in a precipitate; (c) collecting the precipitate as obtained in step (b), after cooling down to room temperature and washing with deionized (DI) water followed by ethanol to obtain a material; (d) drying the material as obtained in step (c), in an oven for a time period in the range of 10 to 12 hrs at a temperature in the range of 50 to 70° C. and stored in a desiccator for future use; (e) the material as obtained in step (c), is in the form of a powder having particle size in nano-dimension in a range of 5 to 100 nm.

In an embodiment of the present disclosure, there is provided a facile process for the synthesis of V-C³H-NSs as an efficient material for electrochromic supercapacitor application which comprises, (a) the preparation of 178 mg metal precursor [Cobalt (II) chloride hexahydrate (CoCl₂·6H₂O), 40 mg of vanadium chloride (VCl₃) solution and 419 mg of urea [NH₂CONH₂] in 30 ml water followed by stirring the mixture for 15 minutes and sonicate for 30 minutes to obtain a reaction mixture solution; (b) transferring the reaction mixture solution to a Teflon-lined 50 ml stainless-steel autoclave and treating in an oven at 120° C. for 12 hrs; (c) collecting the precipitate after cooling down to room temperature and washing with deionized (DI) water followed by ethanol to obtain a material; (d) drying the precipitate at 60° C. for 12 hrs and stored in a desiccator for future use.

In an embodiment of the present invention, there is provided a process for the preparation of vanadium doped cobalt chloride carbonate hydroxide nanostructures (V-C³H-NSs) as disclosed herein, wherein [Cobalt (II) chloride hexahydrate (CoCl₂·6H₂O) and vanadium chloride (VCl₃). are used as the precursor for metal source and urea as a hydrolyzing agent. The present invention provides a unique process for the development of VC³H-NSs.

in an embodiment of the present invention, there is provided a process for the formation of V-C³H-NSs material as disclosed herein wherein, the process can be scaled up further using a higher volume of the constituent reagents at balanced concentrations.

In an embodiment of the present disclosure, as disclosed herein, wherein the formation of the product was confirmed by X-ray diffraction, FESEM, XPS, FTIR and TEM studies.

In an embodiment of the present disclosure, there is provided a process as disclosed herein, wherein the material is in the form of a powder having a particle size in the range of 5-100 nm.

In an embodiment of the present disclosure, as disclosed herein, wherein the V-C³H-NSs material shows excellent Electrochromic Supercapacitor (ECS) properties.

In an embodiment of the present disclosure, there is provided a process as disclosed herein, wherein the prepared material can be formed by drop-casting electrode preparation techniques on a conducting substrate for Supercapacitor studies.

In an embodiment of the present disclosure, there is provided a process as disclosed herein, wherein the material can be formed by drop-casting electrode preparation techniques on a transparent conducting substrate for electrochromic studies.

In an embodiment of the present disclosure, there is provided a process as disclosed herein, wherein the material is stable in alkaline and neutral aqueous medium with efficient electrochromic supercapacitor properties.

In an embodiment of the present disclosure, there is provided a process as disclosed herein, wherein said process for the development of inexpensive energy material made from earth-abundant materials can efficiently be applied for electrochromic supercapacitor application.

In an embodiment of the present disclosure, there is provided a process as disclosed herein, wherein the V-C³H-NSs material exhibits excellent electrochromic supercapacitor properties and opens its potential application to design designing smart windows, smart sunglasses, and devices for optical information and storage.

Although the subject matter has been described in considerable detail with reference to certain examples and implementations thereof, other implementations are possible

### EXAMPLES

The present invention will be more specifically explained by the following examples. However, the scope of the present invention is not limited to the scope of the examples stated below.

### Example-1: (Preparation of Vanadium Doped Cobalt Chloride Carbonate Hydroxide (V-C³H-NSs)

0.178 gm of CoCl₂·6H₂O (HIMEDIA), 0.040 gm of VCl₃ (HIMEDIA), and 0.419 gm of NH₂CONH₂ (HIMEDIA) were taken in a beaker containing 30 ml of millipore water, stirred the solution for 15 min and sonicated for 45 min to obtain a reaction mixture solution. After sonication, the precursors were completely dispersed, and the resultant reaction mixture solution turned light pink color. The reaction mixture solution was transferred in a Teflon-lined 50 ml stainless steel autoclave and treated at 120° C. for 12 hrs to result in a precipitate. The precipitate was collected after cooling down to room temperature and washed several times with DI water followed by ethanol to obtain a material. After that, the material was dried in an oven at 60° C. for 12 hrs and stored in a desiccator for further characterization.

### Example-2: (Preparation of Cobalt Chloride Carbonate Hydroxide (C³H-NSs)

0.178 gm of CoCl₂·6H₂O (HIMEDIA) and 0.419 gm of NH₂CONH₂ (HIMEDIA) were taken in a beaker containing 30 ml of Millipore water and sonicated for 45 min to obtain a reaction mixture solution. After sonication, the precursors were completely dispersed, and the resultant solution is turned into light pink color. The reaction mixture solution was transferred in a Teflon-lined 50 ml stainless steel autoclave and treated at 120° C. for 12 hrs to result in a precipitate. The precipitate was collected after cooling down to room temperature and washed several times with DI water followed by ethanol to obtain a material. After that, the material was dried in an oven at 60° C. for 12 hrs.

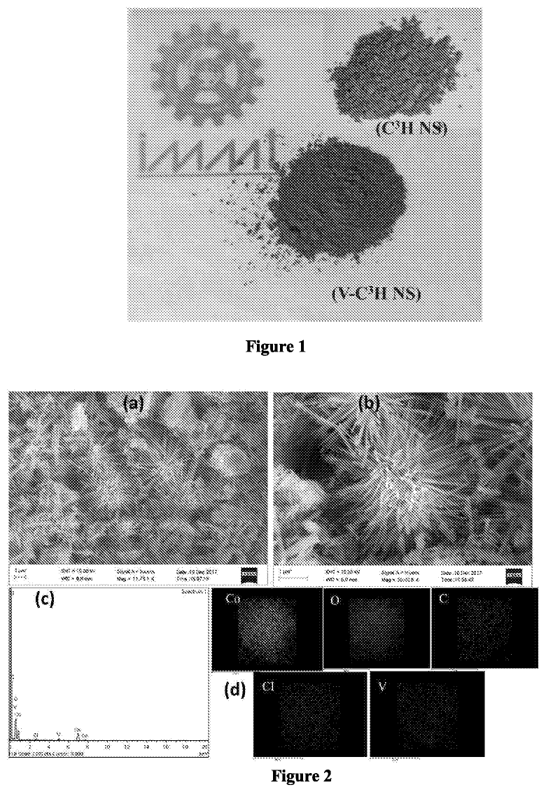

The images of as-prepared V-C³H-NSs and C³H-NSs are shown in FIG. 1.

### Example-3: (Fabrication of Working Electrode for Electrochromic Supercapacitor Study)

Glassy carbon electrodes were used as working electrodes for supercapacitance properties study. The drop-casting method was commonly used for the modification of the working electrode. Before modification, in the first step, the glassy carbon electrode (geometric area=0.071 cm²) was polished with different sized alumina powder of 1 μm, 0.3 μm, and 0.05 μm, respectively. Then repeated washing with deionized water followed by ultrasonication was carried out to get a mirror-like finish surface of the electrode. In the meantime, the sample was also prepared for drop-casting. In brief, the prepared sample for the drop-cast procedure comprised of 1 mg of the material, and 10 μL of Nafion solution dispersed in 190 μL of ethanol, followed by ultrasonication for at least 20 min. Then, 5 μL of the ink was drop-casted onto a Glassy carbon electrode and dried inside a vacuum desiccator. Before the electrochemical experiments, the material-modified electrodes were stored in vacuum desiccators.

In addition to this, for identifying the color-changing properties of V-C³H NSs, a transparent ITO doped glass electrode was used as a current collector. As mentioned above, before modification, in the first step, the ITO doped-glass electrode was cut into a dimension of 2 cm×1 cm. Then, repeatedly washing with deionized water followed by ultrasonication was carried out to clean the electrode's surface. The as-prepared V-C³H NSs sample was drop-casted on ITO doped-glass electrode with a geometrical area of dimension 1 cm² and dried inside a vacuum desiccator. Before the electrochemical experiments, the material-modified electrodes were stored in vacuum desiccators.

### Example 4: Electrochemical Experimental Details for Electrochromic Supercapacitor Study

Electrochemical measurements for the supercapacitor study were performed with the Biologic (VSP-300) workstation. A traditional three-electrode system was used for the electrochemical measurement, which includes the glassy carbon electrode (geometric area=0.071 cm²) modified with active materials as used as working electrode, platinum wire as the auxiliary electrode, Ag/AgCl (3M NaCl) electrode as the reference electrode, and 1M NaOH was used as electrolyte. Cyclic voltammetry (CV) and galvanostatic charge-discharge (GCD) were performed for testing the material for the supercapacitor study. CV measurement was performed by giving a constant potential window at different scan rates ranging from 1 mV/s to 800 mV/s. Similarly, GCD measurement was carried out at different values of current density. The durability of the sample was also tested by CV measurement with increasing the number of cycles up to 12000 cycles and which was found as a stable material for supercapacitor application unless otherwise noted. Like the supercapacitor study, the electrochromic study of the sample was also performed with the Biologic (VSP-300) workstation. A traditional three-electrode system was used for electrochemical measurement. The ITO doped glass electrode (geometric area=1 cm²) modified with active materials was used as a working electrode, platinum wire as the auxiliary electrode, Ag/AgCl (3M NaCl) electrode as the reference electrode, and 1M NaOH was used as electrolyte. Cyclic voltammetry (CV) was performed to test the material's color-changing properties, keeping the potential window constant. In addition to this, chronoamperometry measurement was also performed to identify the different color changes by holding the current value at a constant level for a given period.

### Example 5: Characterization of V-C³H-NSs

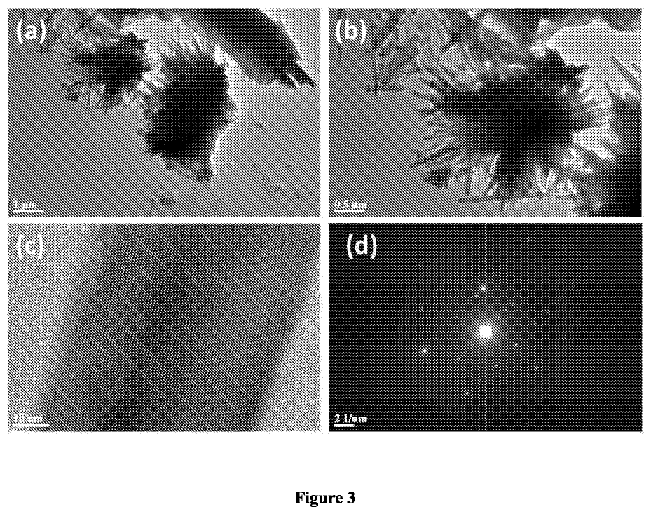

The surface morphology of V-C³H-NSs was studied by FESEM (FIG. 2) and TEM (FIG. 3) analysis. From FESEM techniques, it was clearly observed that flower-like morphology has been observed. The EDS spectrum (FIG. 2c) showed constituent elements like Co, V. O. C. Cl in the sample. The TEM images revealed the same nanoflower-like images are formed (FIG. 3). Further, the HRTEM image revealed the fringe spacing of 0.89 nm corresponding to 100 planes of crystalline V-C³H-NSs material (FIG. 3c). The SEAD pattern displayed the spotty images that confirmed the crystalline nature of V-C³H-NSs (FIG. 3d)

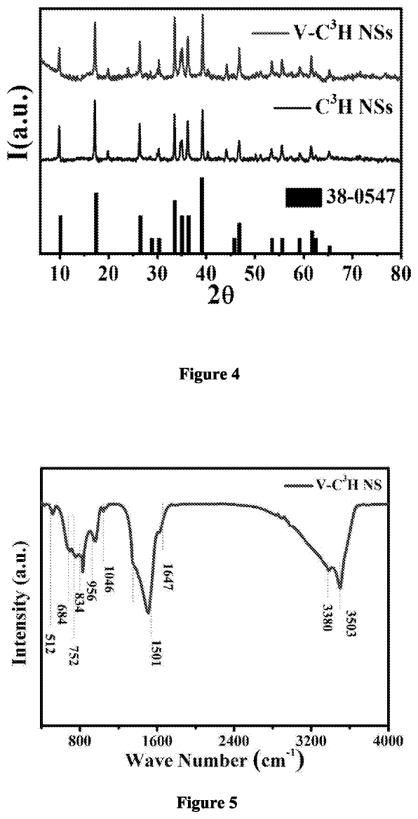

The XRD analysis was carried out for the synthesized materials to know the crystal structure and phase purity, as shown in FIG. 4. From the XRD pattern, the diffraction peaks appeared perfectly indexed the formation of cobalt chloride carbonate hydroxide hydrate having formula Co(OH)_{1.10}Cl_{0.20}(CO₃)_{0.35}·1.74H₂O (JCPDS 38-0547). After incorporating vanadium into the cobalt hydroxide layer, there were no such changes observed in the XRD spectrum. This was due to the amorphous nature of vanadium-based hydroxide.

Further, the FTIR analysis was carried out to know the chemical composition of as-synthesized materials. The FTIR analysis of V-C³H-NSs is shown in FIG. 5. The strong peaks at 3503 cm⁻¹ were due to the O—H bond's vibrational stretching frequency, which indicated the presence of the M-OH layer in the crystal. The peak that appeared at 3380 cm⁻¹ was due to the interaction of the O—H group with carbonate ions. The bands at 1501, 831, 752, and 684 cm⁻¹ were assigned to the stretching vibrations of ν (OCO₂), δ (CO₃), (OCO), ρ(OCO). These peaks were due to the presence of interlayer carbonate ions. The band that arised at 942 cm⁻¹ was ascribed to the M-OH bending vibration, whereas the peak positioned at 511 cm⁻¹ was due to M-O stretching vibration.

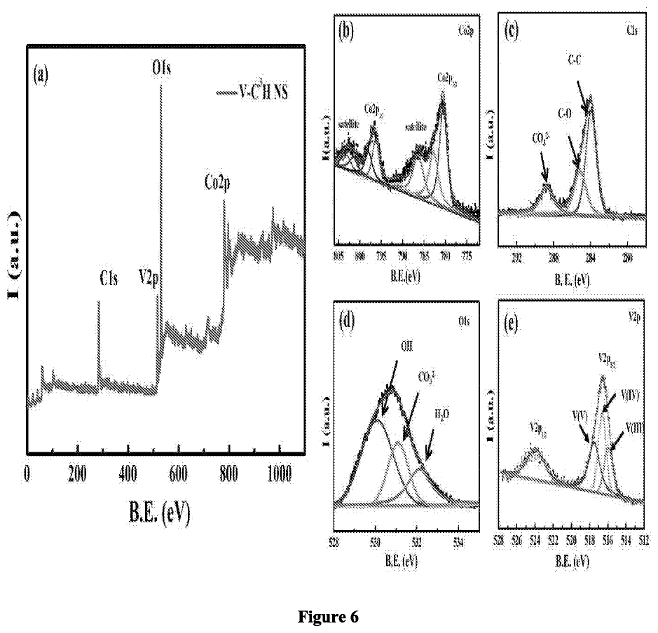

XPS analysis was carried out to know the elemental composition of the V-C³HNSs, which is shown in FIG. 6. From XPS spectra, it was found that constituent elements such as C1s, O1s, V2p, and Co2p peaks were present at their corresponding binding energy (FIG. 6a). The high-resolution XPS spectra of Co is displayed in FIG. 6b. It showed two main structures obtained from the spin-orbit coupling of p-orbitals and gives Co 2p_{1/2} and Co 2p_{3/2}. The two prominent peaks at 780.6 and 796 exist Co²⁺ peaks with two satellite peaks at 797.9 eV and 801.43 eV. Along with the peaks positioned at 782.8 eV, 798 eV was the coexistence of Co³⁺ state with two satellite peaks at 790.51 eV and at 803.27 eV. The high-resolution C1s spectra are shown in FIG. 6c. The C1s spectra was deconvoluted into three peaks. The peak positioned at 284, 285.2, and 289.3 eV was assigned to the characteristic bonds with metal-carbonate and carbonate groups, respectively. FIG. 6d shows the deconvoluted peaks of O1s. The peaks observed at 530.05 eV, 531.08 eV. 532.13 eV were due to metal hydroxyl (M-OH), carbonate (CO₃), and C—OH bonds, respectively. The V2p region gave a signal at 516 eV, and 523 eV is the characteristic of V2p_{3/2} and V2p_{1/2} due to spin-orbit coupling (FIG. 6e). The V2p_{3/2} region deconvoluted into three peaks at 515.89, 516.5, and 517.4 due to V³⁺, V⁴⁺, and V⁵⁺ in the sample. Here, the V³⁺ state was oxidized to V⁴⁺ and V⁵⁺ state during the synthesis process.

### Example 6: Electrochromic Supercapacitor Activity Evaluation

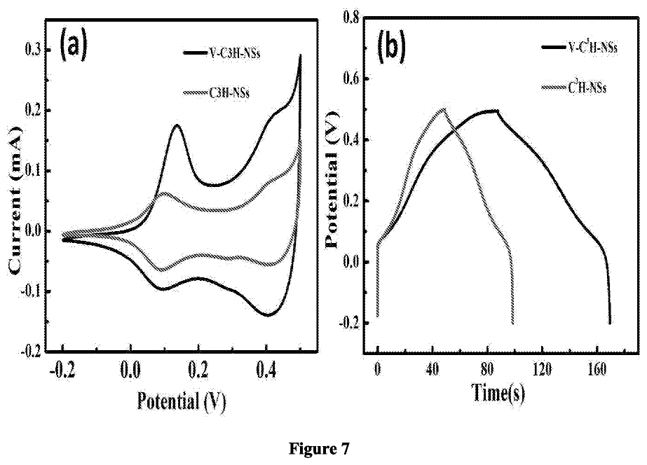

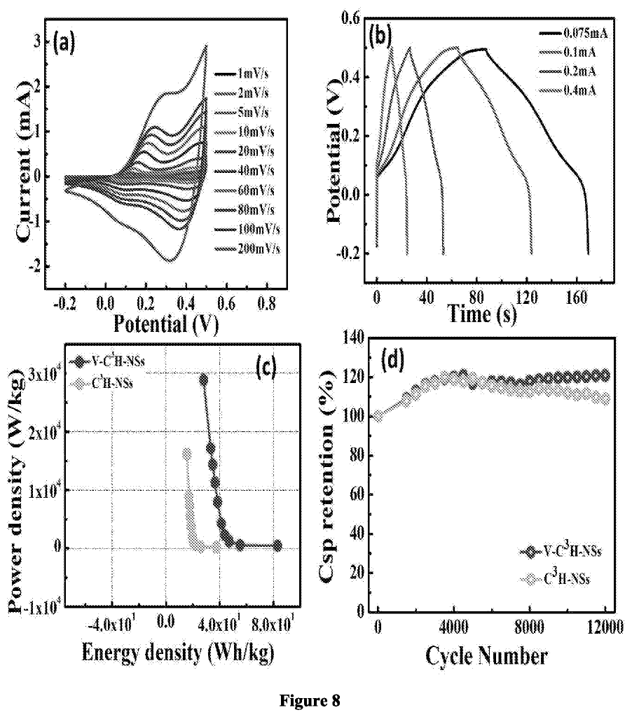

The electrochemical performance was carried out to study the energy storage performance of cobalt chloride carbonate hydroxide and V-C³H-NSs materials. For this purpose, the cyclic voltammetry technique was employed in a three-electrode system at a 0.7V potential window and in a 1M NaOH electrolyte. The CV and CD curve of V-C³HINSs and C³H-NSs material is shown in FIG. 7. At a working potential of −0.2V to 0.5V, the material behaved best. The shape of the CV curves revealed that the capacitance properties of these materials are well different from the capacitance contribution from electrical double layer capacitance. It exhibited a pair of redox peaks at a slow scan rate and higher scan rates, which was associated with the electron transfer reaction in alkaline electrolytes. Two quasi reversible electron transfer reaction was visible at a lower scan rate. The first pair of peaks observed between 0 to 0.2 V was attributed due to the reaction of Co²⁺ to Co³⁺, and the second pair of peaks observed between 0.2 to 0.5 V was attributed due to the conversion of Co³⁺/Co⁴⁺ in the presence of alkaline OH anion in the electrolyte. Here, the oxidized cobalt ion played a vital role in electrochemical capacitance. From CV, the specific capacitance was calculated by integrating the area under the current potential curve by using the following formula.

$${C}_{sp} = {\int }_{E 1}^{E 2} iE ( dE ) / ( {E}_{2} - {E}_{1} ) m υ \qquad ( 1 )$$

Where iE(dE) is the area under the curve, (E₂-E₁) is the potential window taken, m is the mass of electrode material, and v is the scan rate. From the CV curve, V-C³H-NSs gave 1219 Fg⁻¹ at a 1 mVs⁻¹ scan rate. Similarly, the CV technique was carried out for C³HNSs at the same condition presented in FIG. 7a, where a specific capacitance of 551 Fg⁻¹ was obtained at 1 mVs⁻¹ scan rate. At a higher scan rate, the contribution of pseudocapacitance to the total capacitance restricted due to the slow faradic process, which decreased the material's specific capacitance. In the case of V-C³H-NSs, the area under the curve was much more, along with the redox peak. The high capacitance was attributed to the incorporation of vanadium cation into the single-phase cobalt carbonate hydroxide layer. Vanadium hydroxide was an electrochemically active material for supercapacitor application. The partial substitution of Co²⁺ ion by V³⁺ ion increased the electrochemical active surfaces and the overall conductivity of the material. So, V-C³HNSs material gave a better ionic diffusion process more efficiently and reversibly. The presence of interlayer CO₃²⁻ and Cl ion increased the interlayer distance of the metal hydroxides material and increased the easy ion intercalation process resulting in increased pseudocapacitance properties. Here, the presence of vanadium ions increased the overall capacitance behavior of V-C³H-NSs material due to the fact of synergistic effect. To support the CV data, the galvanostatic charge-discharge techniques were carried out at a 0.7 Volt potential window by applying different currents (FIG. 7b). The CD curve VC³H-NSs are presented in FIG. 7b. From CD techniques, the specific capacitance was calculated as follows.

$${C}_{sp} = \frac{It}{m ( {E}_{2} - {E}_{1} )} \qquad ( 2 )$$

where m is the mass of electrode material and t is the discharge time, (E₂-E₁) is the potential window taken at constant current ‘I’. The specific capacitance calculated from the CD technique gives 353 Fg⁻¹ and 216 Fg⁻¹ at 3 Ag⁻¹ current density for V-C³H-NSs and C³H-NSs material. The CV at different scan rates and CD at different current densities of V-C³H-NSs are presented in FIG. 8 (a and b).

Furthermore, the energy density and power density performance were calculated using equations (3) and (4). The following equation calculates the specific energy and power density.

$$Energy density ( E ) = 1 / 2 {{C}_{sp} ( ΔV )}^{2} \qquad ( 3 )$$

$$Power Density ( P ) = 1 / 2 {C}_{sp} ( ΔV ) υ \qquad ( 4 )$$

where Cₛₚ is specific capacitance, ΔV is the potential window in volt, ν is the scan rate. The Ragone plots of E.D. vs. P.D. were made at different scan rates in FIG. 8 (c). From this plot, the E.D. values were 37, 83 Wh kg⁻¹, and P.D. values were 193, 452 W kg⁻¹ at a 1 mVs⁻¹ scan rate for C³H-NSs V-C³H-NSs material, respectively. In order to investigate the cyclic performance of these materials, the CV experiment was carried out at a 100 mVs⁻¹ scan rate over 12000 cycles (FIG. 8d). It was observed that the stability of C³H-NSs material is less stable than the V-C³H-NSs material over the 12000 cycles.

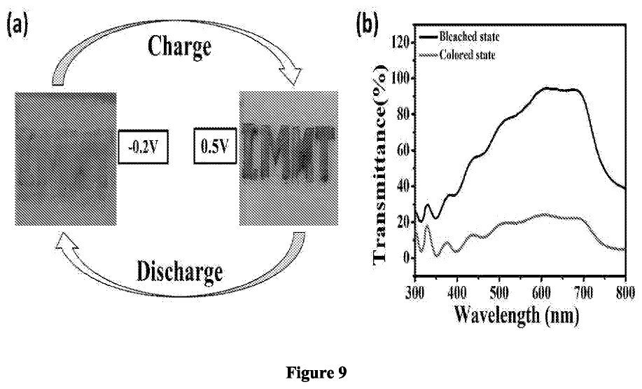

The energy storage and release of the electrochromic material were studied by the effect of color change at +0.7 Volt. For this, a transparent ITO-doped glass electrode was taken by depositing V-C³H-NSs material, and its spectroelectrochemical properties were investigated by monitoring the optical transmittance spectra at a 0.7V potential window (FIG. 9a). The electrochromic device showed a reversible response at a potential range of −0.2 V (neutral) and 0.5V (oxidized state). At −0.2 V, the color of the material was grey; when the electrode material was oxidized, the color changed to black as well as the transmittance band appears at 600 nm is intensified (FIG. 9b). The optical modulation (ΔT) and coloration efficiency were estimated to be 69% and 65 cm²c⁻¹ from the UV-Visible transmittance spectra.

### Advantages of the Invention

The vanadium doped cobalt chloride carbonate hydroxide nanostructures (V-C³H-NSs) prepared by the facile process is inexpensive material made from earth-abundant materials that can efficiently apply as electrochromic supercapacitor (ECS) applications.

The advantages of the method are given below.
1. The above-mentioned inventions are a novel, new and simple process of preparation of V-C³H-NSs.
2. The preparation of V-C³H-NSs includes the use of very inexpensive chemicals.
3. The preparation of V-C³H-NSs includes easy steps.
4. V-C³H-NSs are used as electrochromic supercapacitor applications.
5. It opens the horizon of a new class of materials to design for electrochromic supercapacitor devices useful in designing intelligent windows, smart sunglasses, and optical information and storage devices.

We claim:

1. A process for the preparation of vanadium doped cobalt chloride carbonate hydroxide nanostructures (V-C³H-NSs), the process comprising the steps of:
(a) adding 20-25 mM of [Cobalt (II) chloride hexahydrate (CoCl₂·6H₂O), 5-10 mM vanadium chloride (VCl₃) and 220-240 mM of urea (NH₂CONH₂) in 30 ml of water, followed by stirring for 15 to 30 minutes and sonicate for 30 to 45 minutes to obtain a reaction mixture solution;
(b) transferring the reaction mixture solution as obtained in step (a) to a Teflon-lined 50 ml stainless-steel autoclave and treating in an oven at 120° C.-160° C. for 10-15 hrs to result in a precipitate;
(c) collecting the precipitate as obtained in step (b) after cooling down to room temperature and washing with deionized (DI) water followed by ethanol to obtain a material;
(d) drying the material as obtained in step (c), in an oven for a time period in the range of 10 to 12 hrs at a temperature in the range of 50 to 70° C. and stored in a desiccator for future use; and
(e) the material as obtained in step (c), is in the form of a powder having particle size in nano-dimension in a range of 5 to 100 nm.

2. The process as claimed in claim 1, wherein CoCl₂·6H₂O and VCl₃ are used as the precursor for Co and V sources for the formation of V-C³H-NSs.

3. The process as claimed in claim 1, wherein urea is used as hydrolyzing agent for the precipitation and formation of V-C³H-NSs.

4. The process as claimed in claim 1, wherein the material exhibits electrochromic supercapacitor properties with a capacitance value of 1219 F/g, optical modulation (ΔT) of 69%, and coloration efficiency value of 65 cm²C⁻¹.

5. The process as claimed in claim 1, wherein the material exhibits stability for electrochromic supercapacitor properties in alkaline and neutral aqueous medium.
